(19) United States
(12) Patent Application Publication
(10) Pub. No.: US 2022/0214706 A1
(43) Pub. Date: Jul. 7, 2022

(54) ELECTRIC HEATERS

(71) Applicant: Tutco, LLC, Cookeville, TN (US)

(72) Inventors: Andrew Chanul Kim, Fremont, CA (US); Pedro Andres Garzon, San Jose, CA (US); Dexter Eugene Diepholz, Hendersonville, NC (US); Ronald T. Rittenhouse, Dover, NH (US)

(73) Assignee: Tutco, LLC, Cookeville, TN (US)

(21) Appl. No.: 17/646,781

(22) Filed: Jan. 3, 2022

Related U.S. Application Data
(60) Provisional application No. 63/134,240, filed on Jan. 6, 2021.

(51) Int. Cl. G05D 23/19; H05B 3/00; G08B 21/18

(52) U.S. Cl. CPC G05D 23/1917; G08B 21/182; H05B 3/0019

(57) ABSTRACT

One aspect of the invention provides an electric heater including: a resistive heating element; a current transformer positioned around a portion of the resistive heating element or a lead thereto, the current transformer adapted and configured to produce a secondary induced current proportional to a primary current flowing through the resistive heating element; and a controller communicatively coupled to the resistive heating element and the current transformer. The controller is programmed to either: (i): detect a deviation between the secondary induced current and a reference value; and in response to the deviation, generate an alert; or (ii) communicate to a remote server programmed to detect a deviation between the secondary induced current and a reference value.

### CROSS-REFERENCE TO RELATED APPLICATION

This application claims the benefit of priority to U.S. Provisional Patent Application Ser. No. 63/134,240, filed Jan. 6, 2021. The entire content of this application is hereby incorporated by reference herein.

### BACKGROUND OF THE INVENTION

Heaters are used in various manufacturing and climate control applications.

### SUMMARY OF THE INVENTION

One aspect of the invention provides an electric heater including: a resistive heating element; a current transformer positioned around a portion of the resistive heating element or a lead thereto, the current transformer adapted and configured to produce a secondary induced current proportional to a primary current flowing through the resistive heating element; and a controller communicatively coupled to the resistive heating element and the current transformer. The controller is programmed to either: (i): detect a deviation between the secondary induced current and a reference value; and in response to the deviation, generate an alert; or (ii) communicate to a remote server programmed to detect a deviation between the secondary induced current and a reference value.

This aspect of the invention can have a variety of embodiments. The controller can include a microprocessor.

The electric heater can further include a housing surrounding the resistive heating element, the current transformer, and the controller. The controller can be mounted an internal wall of the housing. The housing can be fabricated from a plastic.

The electric heater can further include a temperature sensor along an output path. The controller can be communicatively coupled to the temperature sensor. The controller can be further programmed to implement a closed-loop feedback method to control the primary current to achieve a specified temperature along the output path.

The controller can be programmed to communicate the secondary induced current to the remote server.

Another aspect of the invention provides an electric heater including: a resistive heating element; a temperature sensor along an output path; a controller communicatively coupled to the resistive heating element and the current transformer, the controller programmed implement a closed-loop feedback method to control the primary current to achieve a specified temperature along the output path; and a housing surrounding the resistive heating element, the temperature sensor, and the controller. The controller is mounted an internal wall of the housing.

### BRIEF DESCRIPTION OF THE DRAWINGS

For a fuller understanding of the nature and desired objects of the present invention, reference is made to the following detailed description taken in conjunction with the accompanying drawing figures wherein like reference characters denote corresponding parts throughout the several views.

FIG. 1 is a block diagram of an electric heater according to an embodiment of the invention.

FIG. 2 is a block diagram of a controller according to an embodiment of the invention.

FIG. 3 is a perspective external view of an electric heater according to an embodiment of the invention.

FIGS. 4-6 are perspective internal views of an electric heater according to embodiments of the invention.

FIG. 7 is a perspective external view of an electric heater according to an embodiment of the invention.

FIGS. 8 and 9 are root mean square (RMS) graphs over time of current values measured by an electric heater according to embodiments of the invention.

### DEFINITIONS

The instant invention is most clearly understood with reference to the following definitions.

As used herein, the singular form “a,” “an,” and “the” include plural references unless the context clearly dictates otherwise.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from context, all numerical values provided herein are modified by the term about.

As used in the specification and claims, the terms “comprises,” “comprising,” “containing,” “having,” and the like can have the meaning ascribed to them in U.S. patent law and can mean “includes,” “including,” and the like.

Unless specifically stated or obvious from context, the term “or,” as used herein, is understood to be inclusive.

Ranges provided herein are understood to be shorthand for all of the values within the range. For example, a range of 1 to 50 is understood to include any number, combination of numbers, or sub-range from the group consisting 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, or 50 (as well as fractions thereof unless the context clearly dictates otherwise).

### DETAILED DESCRIPTION OF THE INVENTION

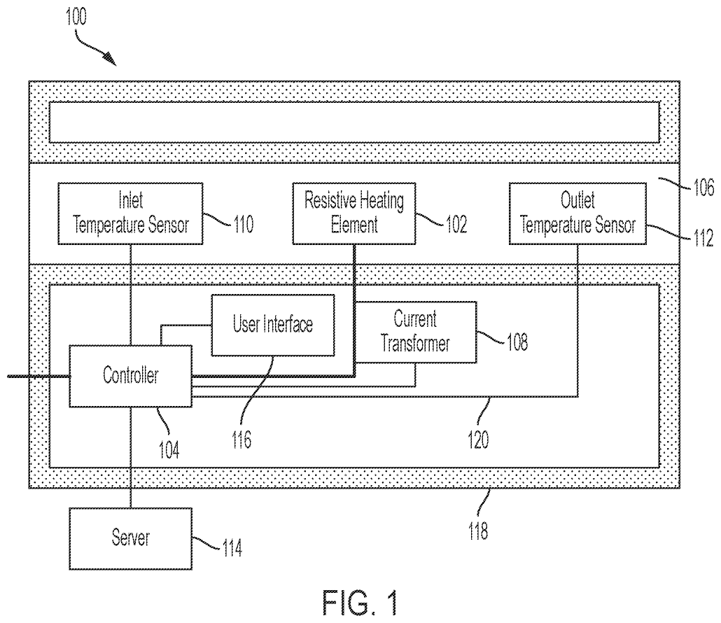

Referring now to FIG. 1, one aspect of the invention provides an electric heater 100 including a resistive heating element 102 and a controller 104.

The resistive heating element 102 can heat a medium (e.g., air flowing through a channel 106) using the Ohmic heating produced when electrical current passes through the conductor. In one embodiment, the resistive heating element 102 is a nickel-chromium (nichrom) alloy.

### Controller

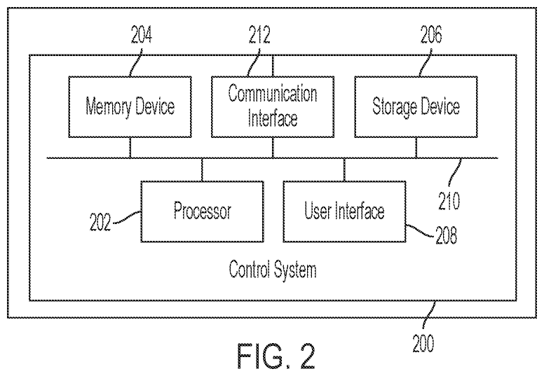

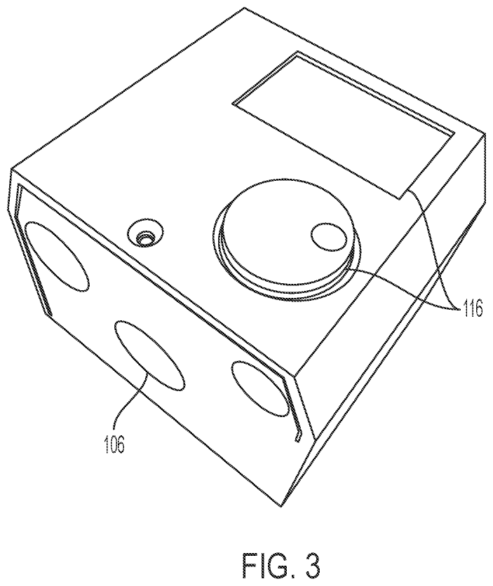

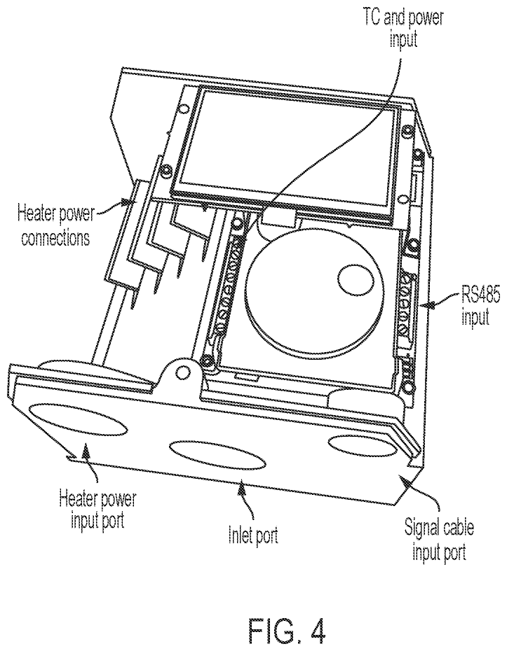

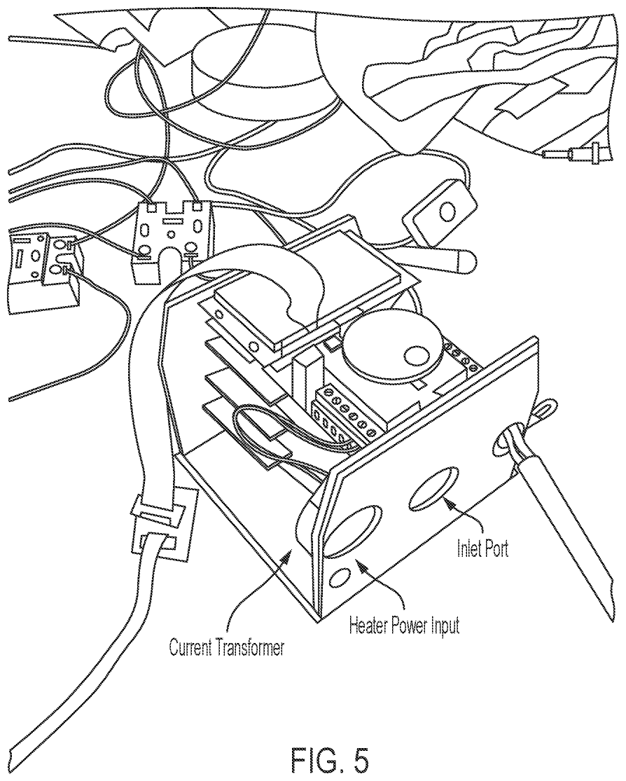

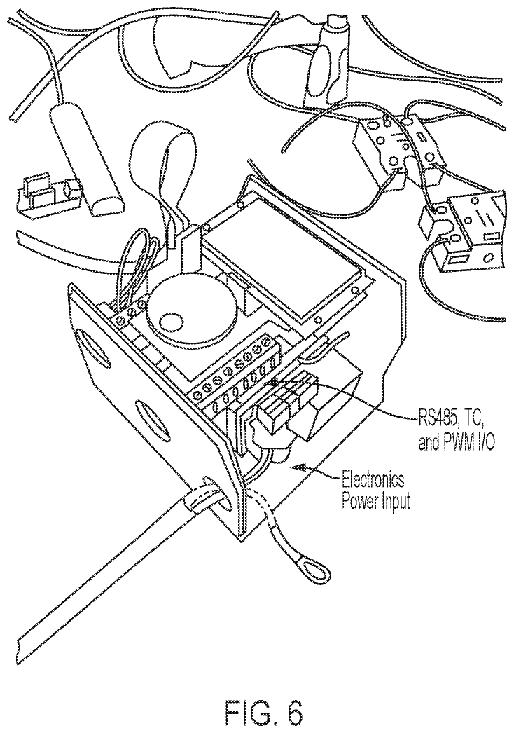

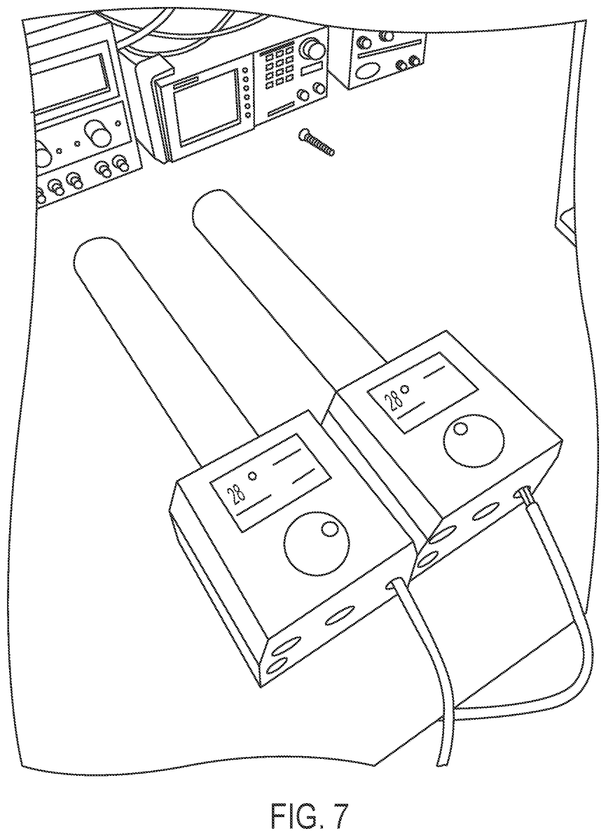

Controller 104 can be a microcontroller (e.g., available under the ARDUINO® OR IOIO™ trademarks), a microprocessor, and the like. Referring to FIG. 2, the controller 200, which can be an example of the controller 104 of FIG. 1, can include a processor device (e.g., a central processing unit or “CPU”) 202, a memory device 204, a storage device 206, a user interface 208, a system bus 210, and a communication interface 212.

The processor 202 can be any type of processing device for carrying out instructions, processing data, and so forth.

The memory device 204 can be any type of memory device including any one or more of random access memory (“RAM”), read-only memory (“ROM”), Flash memory, Electrically Erasable Programmable Read Only Memory (“EEPROM”), Secure Digital (“SD”), and the like.

The storage device 206 can be any data storage device for reading/writing from/to any removable and/or integrated optical, magnetic, and/or optical-magneto storage medium, and the like (e.g., a hard disk, a compact disc-read-only memory “CD-ROM”, CD-ReWritable CDRW,” Digital Versatile Disc-ROM “DVD-ROM”, DVD-RW, and so forth). The storage device 206 can also include a controller/interface for connecting to the system bus 210 (e.g., using the RS-485 standard). Thus, the memory device 204 and the storage device 206 are suitable for storing data as well as instructions for programmed processes for execution on the processor 202.

The user interface 208 can include a touch screen, control panel, keyboard, keypad, display or any other type of interface, which can be connected to the system bus 210 through a corresponding input/output device interface/adapter.

The communication interface 212 can be adapted and configured to communicate with any type of external device, or with other components of the electric heater 100. For example and referring again to FIG. 1, thin lines, such as line 120, illustrate communications (e.g., wired or wireless) between the controller 104 of FIG. 1 and another component of the electric heater 100 (e.g., current transformer 108, inlet temperature sensor 110, outlet temperature sensor 112, and the like). The communication interface 212 can further be adapted and configured to communicate with any system or network, such as one or more computing devices (e.g., server 114) on a local area network (“LAN”), wide area network (“WAN”), the Internet, and so forth using various protocols such as MODBUS, BLUETOOTH, and the like. The communication interface 212 can be connected directly to the system bus 210 or can be connected through a suitable interface.

The control system 200 can, thus, provide for executing processes, by itself and/or in cooperation with one or more additional devices, that can include algorithms for controlling components of the electric heater 100 in accordance with the claimed invention. The control system 200 can be programmed or instructed to perform these processes according to any communication protocol and/or programming language on any platform. Thus, the processes can be embodied in data as well as instructions stored in the memory device 204 and/or storage device 206, or received at the user interface 208 and/or communication interface 212 for execution on the processor 202.

### Inputs and Outputs

Referring again to FIG. 1, controller 104 can include a variety of inputs and outputs.

Controller 104 can receive electricity (e.g., alternating current or direct current), e.g., from a wall socket, cord, bus, and the like. The electricity can be of the form typical in the user's market (e.g., 110V, 120V, 127V, 220V, 230V, 240V, and the like). The electric heater 100 and/or controller 104 can include one or more transformers adapted and configured to accept multiple voltages. The controller 104 can be programmed to regulate the output of electricity to the resistive heating element 102.

A desired temperature can be specified using user interface 116, which can be accessible on an outer surface of housing 118. In some embodiments, the user interface 116 includes an input device such as a dial, keypad, and the like. The user interface 116 can optionally include a display device such as a screen, a liquid-crystal display, an one or more light-emitting diodes (LEDs), an organic LED (OLED) screen, and the like. In some cases, user interface 208 of FIG. 2 can be an example of the user interface 116. A desired temperature can additionally or alternatively be specified remotely, e.g., using wired or wireless communications from a device such as a portal, computer, tablet, and/or smartphone.

For example, controller 104 can receive input from one or more temperature sensors 110, 112 (e.g., those that measure a temperature of air upstream and/or downstream from the resistive heating element 102) and use those inputs to produce the temperature specified by user input received at the user interface 116. The principles of how to use feedback (e.g., from a temperature sensor) in order to modulate operation of a component are described, for example, in Karl Johan Astrom & Richard M. Murray, Feedback Systems: An Introduction for Scientists & Engineers (2008).

The user interface 116 provide visual or audio feedback regarding the status of the electric heater 100. For example, the user 116 can display blue to indicate that the heater is below the setpoint, green to indicate that the heater is at the set point, and red to indicate that the heater is above the setpoint. This feedback can be modified by a buffer (e.g., displaying green if within 5° C. of the setpoint). The user interface can also graphically display historical temperature data.

The user interface 116 can be lockable using a password, which can be entered using an optional dial in a manner similar to a combination padlock.

### Integration of Components

Embodiments of the invention can advantageously be integrated into a single unit that includes closed-loop feedback without the cost (both equipment and installation) of an external controller. For example, all components of the heating system 100 can be integrated within a housing 118 (e.g., made from a plastic or metal). The controller 104 can be mounted on the housing 118 and spaced from the resistive heating element 102 to prevent thermally induced malfunctions or damage.

### Prediction of Resistive Heating Element Failure

Embodiments of the invention can advantageously predict when resistive heating element 102 is likely to fail or has failed.

Referring again to FIG. 1, a current transformer 108 can be positioned around a portion of the resistive heating element 102 or a lead thereto. The current transformer 108 can be adapted and configured to produce a secondary induced current proportional to a primary current flowing through the resistive heating element 102.

One or more reference values can be stored, e.g., in controller 104 or server 114. The reference value can be measured for a particular electric heater 100 (e.g., at design, at manufacture, at installation, at start-up, after servicing, and the like) or can be specified for a particular model or class of electric heater 100.

Controller 104 and/or server 114 can be programmed to calculate a deviation between the reference value and a measured value. The controller 104 and/or server 114 can monitor data received corresponding to measured values from the current transformer 108. In some cases, the controller 104 and/or server 114 can identify whether a given measurement reading from the current transformer falls below a defined threshold. For example, the controller 104 and/or server 114 can store a threshold in terms of absolute values (e.g. current values), or a value percentage. In some cases, the controller 104 and/or server 114 can store a lookup table of percentage values or absolute values of readings in relation to the age of the resistive heating element 102. If the deviation exceeds a defined threshold (e.g., in absolute terms or percentage), the controller 104 and/or server 114 can predict that the resistive heating element 102 is likely to fail and generate a corresponding alert.

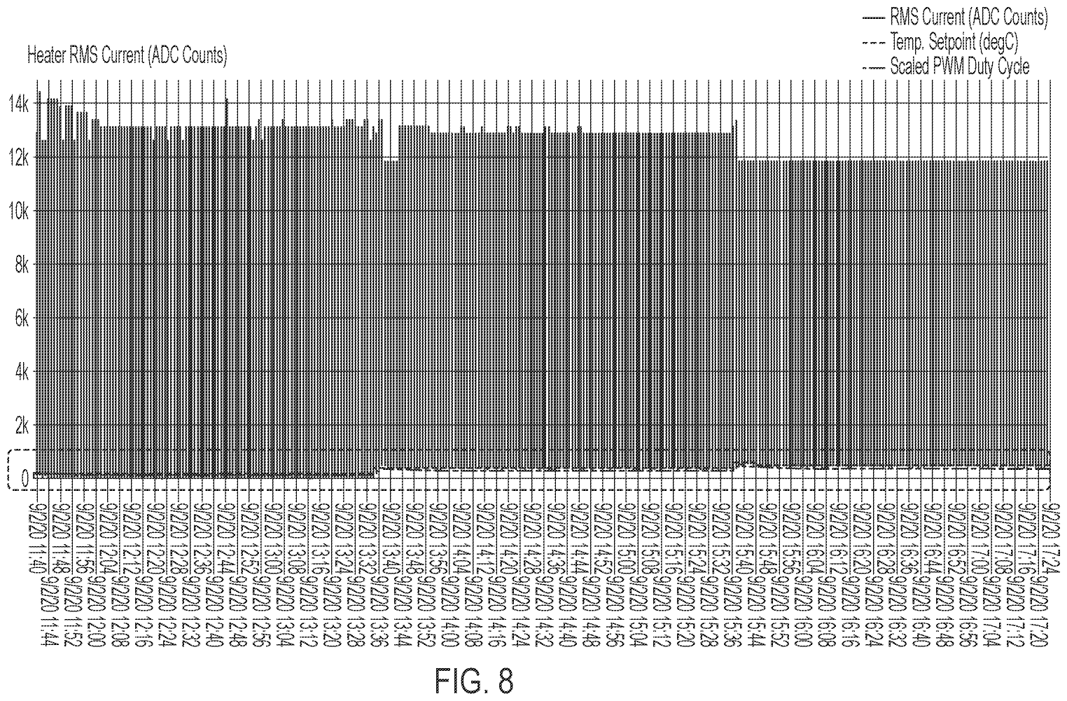

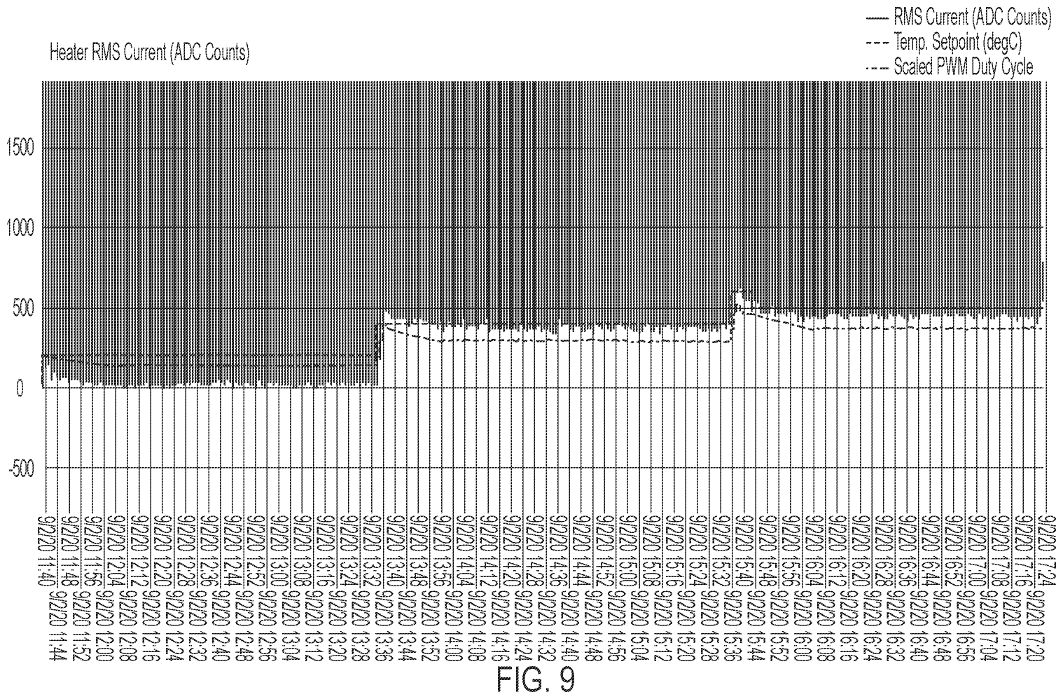

In some cases, the controller 104 and/or server 114 can monitor patterns of measurement readings. For example, the controller 104 and/or server 114 can collect multiple measurement readings from the current transformer 108 over time, which can depicted as a plot over time. Examples of this generated plot are depicted in FIGS. 8 and 9, which depict root mean square (RMS) current measurement readings of a current transformer (e.g., current transformer 108) over a period of time. The controller 104 and/or server 114 can store thresholds pertaining to measurement reading patterns that, if the reading plot of the current transformer readings exceeds, the controller 104 and/or server 114 can determine a fault condition. For example, the controller 104 and/or server 114 can monitor deviations between different data points corresponding to measurements of the current transformer 108 over a period of time. If the deviation between different data points exceeds the threshold, the controller 104 and/or server 114 can determine a fault condition.

In some cases, thresholds can be generated from monitoring measurements received from one or more electric heaters. For example, the server 114 can receive and store measurements from multiple electric heaters. The server 114 can monitor these measurements over a period of time, and can detect standard or typical measurement readings received from electric heaters (e.g., identify normal wear or degradation of the resistive heating element 102 over time). For example, as the resistive heating element 102 ages over time, the cross-section of the resistive heating element 102 can reduce due to oxidation. This can lead to an increase in resistance

$$( R = ρ \frac{Length}{Cross \text{-} Sectional Area} ) .$$

Reduction in Cross-Sectional Area can be inferred from the current measurement (assuming constant voltage) from Ohm's Law (V=IR). The server 114 and/or controller 104 can identify normal wear (e.g., typical cross-section reduction) of the resistive heating element via measurements received from one or more electric heaters 100. In some embodiments, historical measurements and events (e.g., failures) can be used to train an artificial intelligence or machine learning algorithm to predict future failures.

Controller 104 and/or server 114 can also be programmed to detect other fault conditions such as overheating, temperature sensor failure, and the like. In some cases, resistance and/or voltage values may be measured directly in lieu of, or in combination with, the current measurements taken by the current transformer 108.

### EQUIVALENTS

Although preferred embodiments of the invention have been described using specific terms, such description is for illustrative purposes only, and it is to be understood that changes and variations may be made without departing from the spirit or scope of the following claims.

### INCORPORATION BY REFERENCE

The entire contents of all patents, published patent applications, and other references cited herein are hereby expressly incorporated herein in their entireties by reference.

1. An electric heater comprising:
a resistive heating element;
a current transformer positioned around a portion of the resistive heating element or a lead thereto, the current transformer adapted and configured to produce a secondary induced current proportional to a primary current flowing through the resistive heating element; and
a controller communicatively coupled to the resistive heating element and the current transformer, the controller programmed to either:
(i):
detect a deviation between the secondary induced current and a reference value; and
in response to the deviation, generate an alert; or
(ii) communicate to a remote server programmed to detect a deviation between the secondary induced current and a reference value.

2. The electric heater of claim 1, wherein the controller comprises a microprocessor.

3. The electric heater of claim 1, further comprising:
a housing surrounding the resistive heating element, the current transformer, and the controller.

4. The electric heater of claim 3, wherein the controller is mounted an internal wall of the housing.

5. The electric heater of claim 3, wherein the housing is fabricated from a plastic.

6. The electric heater of claim 1, further comprising:
a temperature sensor along an output path.

7. The electric heater of claim 6, wherein the controller is communicatively coupled to the temperature sensor.

8. The electric heater of claim 7, wherein the controller is further programmed to implement a closed-loop feedback method to control the primary current to achieve a specified temperature along the output path.

9. The electric heater of claim 1, wherein the controller is programmed to communicate the secondary induced current to the remote server.

10. An electric heater comprising:
a resistive heating element;
a temperature sensor along an output path;
a controller communicatively coupled to the resistive heating element and the current transformer, the controller programmed implement a closed-loop feedback method to control the primary current to achieve a specified temperature along the output path; and
a housing surrounding the resistive heating element, the temperature sensor, and the controller;
wherein the controller is mounted an internal wall of the housing.
